(19) United States
(12) Patent Application Publication
(10) Pub. No.: US 2024/0288028 A1
(43) Pub. Date: Aug. 29, 2024

(54) HOLLOW SHAFT FOR AN ELECTRIC MOTOR

(71) Applicants: BENTELER AUTOMOBILTECHNIK GMBH, Paderborn (DE); BENTELER STEEL/TUBE GmbH, Paderborn (DE)

(72) Inventors: Eugen AUL, Bad Salzuflen (DE); Nicole ROTZOLL, Paderborn (DE); Andreas POMRISCH, Salzkotten (DE); Sandor SCHUMANN, Delbrueck (DE)

(21) Appl. No.: 18/565,714

(22) PCT Filed: May 19, 2022
(86) PCT No.: PCT/DE2022/100380

§ 371 Date: Mar. 20, 2024

(30) Foreign Application Priority Data
Jun. 1, 2021 (DE) 10 2021 114 179.6

(51) Int. Cl. F16C 3/02

(52) U.S. Cl. CPC F16C 3/023; F16C 2380/26

(57) ABSTRACT

The present disclosure relates to a hollow shaft for an electric motor, which has a hollow cylindrical shaft body, wherein the shaft body has at least two rotationally symmetrical hollow components, which are positioned one inside the other and joined together using soldering, wherein a first hollow component has a central through opening having an inner diameter and a further hollow component is inserted in the first hollow component, wherein the further hollow component is joined to the inner circumference of the through opening of the first hollow component while bearing thereon.

### RELATED APPLICATIONS

The present application is a National Phase of International Application Number PCT/DE2022/100380, filed May 19, 2022 and claims priority of German Application Number 2021 114 179.6 filed Jun. 1, 2021.

### FIELD

The disclosure relates to a hollow shaft for an electric motor.

### BACKGROUND

In the context of the disclosure, a hollow shaft for an electric motor is a rotor shaft, a transmission shaft, or a connecting shaft. A connecting shaft is located in an electric motor between a rotor shaft and a transmission shaft.

A central component of an electric motor, for example, is the rotor shaft. The rotor shaft is the supporting component for the laminated core of the rotor and transmits the electrically induced torque into the transmission via a formfitting connection. In addition to the mounting of the rotor and various add-on parts or components, the cooling concept for the electric motor influences the design and formation of the rotor shaft. At least one of the electric motor function is the torque transfer of electrical energy into kinetic energy in the transmission, wherein the rotor shafts are subjected to heavy loads due to the very high speeds and high torques. High-strength components are therefore necessary, but they are also to be as light as possible.

A rotor shaft for a rotor of an electric motor is described in DE 10 2018 130 557 A1. The rotor shaft is designed as a hollow shaft or as a solid shaft. These each have a helical rib and/or recess extending in the longitudinal direction of the rotor shaft in order to convey a cooling fluid in the longitudinal direction of the rotor shaft when the rotor shaft rotates.

According to DE 10 2019 112 790 A1, a rotor shaft arrangement is described, wherein a rotor is arranged on a rotor shaft. The rotor is designed as a laminated core. The rotor shaft has an inner channel for introducing a coolant. On the outside of the rotor shaft, external teeth are provided, via which the rotor shaft is in rotationally fixed engagement with internal teeth of the rotor. At least one external channel for introducing a coolant is formed between the external teeth of the rotor shaft and the internal teeth of the rotor.

DE 10 2008 043 367 A1 describes an electric machine having a hollow shaft. The hollow shaft carries a rotor around which a stator is fixedly arranged. The electric machine has means for conveying a cooling fluid through the hollow shaft.

A hollow shaft in the form of a rotor laminated core section, which is joined in a formfitting manner to a shaft stub, is described in DE 10 2018 204 692 A1. The rotor shaft extends through the rotor and has longitudinal sections on both sides of the rotor. This allows a rotor-rotor shaft arrangement to be produced in a simple and cost-effective manner.

DE 10 2018 130 516 A1 also shows a rotor shaft for an electrical machine, which is designed as a hollow shaft. A coolant distribution element is arranged in the interior of the hollow shaft. The coolant ensures efficient cooling of the gap and the hollow shaft itself.

Rotor shafts for electric motors are able to be designed as hollow shafts or solid shafts. The heat generated during operation of an electric motor is dissipated in order to reduce the thermal loads on the components of the electric motor. Passive cooling occurs via thermally conductive contact with motor parts or components, such as the shaft bearings of the electric motor. Active cooling is increasingly carried out by means of fluids, for example, air or liquids. Here, the rotor shafts, as fluid-carrying hollow shafts, are cooled from the inside using a cooling fluid.

The hollow shafts are produced from welded or seamless tubes and then formed and mechanically processed. Necessary functional elements, such as teeth, are then introduced using suitable shaping or forming methods.

The increased demands on the thermal management of an electric motor require a more complex design of the hollow shafts of the electric motor, for example, internal geometries thereof. In addition, there is a requirement for lightweight and, economical production of components in large quantities. The focus is on optimized cooling of the hollow shafts, such as the rotor shaft, during operation, in the respective operating points of a cooling pump. A complex design of the internal geometry of the hollow shafts is sought in order to generate as much turbulence as possible and avoid dead flow areas. The latter is able to result in an unfavorable distribution of heat within the system, especially the rotor shaft, and cause failure not only of the rotor shaft, but also of peripheral components. A high degree of freedom in the design of the internal geometry of the hollow shafts in order to be able to manufacture them economically at the same time is also important.

The internal geometry of a hollow shaft is produced using pipe forming processes such as constricting, kneading, or expanding. Shafts having multi-part forged parts and are joined together in a materially bonded manner, for example by means of a circular laser seam, are also used in the field of electric motor construction. In any case, subsequent mechanical processing takes place to ensure the required precision. This is followed by heat treatment in order to achieve a tempered state or to partially harden components. The volume to be machined, which results due to the forming processes and the pipe tolerances, is comparatively high, so that processing periods are correspondingly time-intensive and cost-intensive. The design freedom with regard to the internal geometry is limited because the creation of undercuts is not possible or only possible to a limited extent or is so severely restricted that economical production reaches its limits. The shafts are also regularly designed to be monolithic or made of the same material, so that the respective functional surfaces cannot be optimally designed for their functions.

### SUMMARY

The disclosure relates to a functionally and technically improved hollow shaft for an electric motor, for example, a rotor shaft, a transmission shaft, or a connecting shaft, which has a high degree of freedom in the design of the internal geometry and is able to be manufactured efficiently in a lightweight construction.

The electric motor hollow shaft has a hollow cylindrical shaft body, which has at least two rotationally symmetrical hollow components, which are positioned one inside the other and joined together using soldering. The hollow shaft, which is simply constructed and efficiently manufactured, meets the highest requirements for the thermal management of an electric motor. Complex but easy-to-implement internal geometries of an electric motor hollow shaft are able to be implemented. At the same time, the hollow shaft according to the disclosure is able to be designed in lightweight construction.

In at least one embodiment, a hollow shaft according to the disclosure for an electric motor is a rotor shaft, a transmission shaft, or a connecting shaft, which is able to be integrated directly or indirectly between a rotor shaft and a transmission shaft.

The hollow shaft according to the disclosure implements a weight-optimized design made of matched, rotationally symmetrical hollow components. Rotationally symmetrical hollow components in the sense of the disclosure are pipe sections, pipe pieces and/or pipe components that form a constructed hollow shaft body. In this way the weight is able to be reduced significantly. The production process of the hollow shaft is also able to be broken down into sub-processes, which make reduce the overall cycle time when manufacturing large quantities. According to the disclosure, the geometry of the hollow shaft is also able to be adapted in a purpose-optimized manner to the performance of the electric motor and the configuration of the thermal management, i.e., the cooling system of an electric motor hollow shaft, for example a rotor shaft.

According to the disclosure, a hollow shaft has at least two rotationally symmetrical hollow components that are joined together using high-temperature soldering. These hollow components are able to be geometrically configured in the same way, for example, pipe sections having the same or different lengths. The shaft body has a first rotationally symmetrical hollow component in the form of a pipe section, which forms the supporting body. This has a length that extends over the length of the shaft body. In this supporting body, further rotationally symmetrical hollow components, such as in the form of pipe sections, are joined by material bonding using soldering. The supporting body accommodates further hollow components or pipe sections inside or outside, or further hollow components, such as pipe sections, are secured by material bonding to the supporting body. The other hollow components or pipe sections are shorter than the pipe section forming the supporting body and are able to have a wall thickness that deviates from the supporting body.

Rotationally symmetrical hollow components in the form of two pipe sections of equal length or unequal length are positioned and joined one inside the other and form the shaft body. The pipe sections are able to have the same material or of different metallic materials having different material or strength characteristics.

The rotationally symmetrical hollow components of the shaft body are matched to the respective functional purpose and designed, for example, with regard to corrosion resistance, tensile strength, ductility, or also their mechanical machinability.

In at least one embodiment of the disclosure, a first rotationally symmetrical hollow component forms the supporting body of the shaft body, has a central through opening having an inner diameter. A further second rotationally symmetrical hollow component is inserted into the first hollow component, wherein the further second hollow component bears on the inner circumference of the through opening of the first hollow component and is joined thereto. In addition to the second hollow component, further hollow components are able to be joined in or on the first hollow component.

A hollow component is able to be a relatively short pipe piece. The pipe piece is positioned and joined in the first hollow component. A second hollow component in the form of a pipe section or a pipe piece is able to be joined on the outside of the outer circumference of the first hollow component. In this embodiment, the pipe piece surrounds the first hollow component on the outer circumference along its lateral surface. The pipe piece is therefore arranged radially to the first hollow component, for example a pipe section, and is joined to the outer circumference of the first hollow component.

A rotationally symmetrical hollow component also includes pipe components having a hollow cylindrical cross section, pipe sections, pipe pieces, and also rotationally symmetrical forged pipe pieces.

In at least one embodiment of the disclosure, a third rotationally symmetrical hollow component is positioned on the outer circumference of the first hollow component and is joined thereto using soldering.

A bearing seat is formed or arranged at least at one end of a hollow component. The bearing seat is able to be produced by turning out or turning off on the inner circumference of the first hollow component. A bearing seat is also able to be formed in a hollow component, which is placed and joined at the end face in or on a hollow component, which forms the supporting body of the shaft body.

In the hollow shaft according to the disclosure, the shaft body is able to be constructed from rotationally symmetrical hollow components in the form of pipe sections or have pipe sections which including different metallic materials. Such an embodiment allows for a further increase in efficiency, with regard to heat dissipation, i.e., the cooling system of the rotor shaft, and also with regard to the design of the internal geometry. Individual hollow components are able to be designed in terms of material with regard to main functions, for example if a bearing seat will be or is formed in or on them. In at least one embodiment, a first hollow component forming the supporting body of the shaft body has a different tensile strength and elongation at fracture than a second rotationally symmetrical hollow component joined to the end thereof.

The hollow component is joined by material bonding using high-temperature soldering technology by means of a copper-based solder. Alternatively, the hollow components are also able to be joined by means of a nickel-based or iron-based solder.

In at least one embodiment of the disclosure, the hollow component or components have a profiling on the inner circumference and/or on the outer circumference. Profiling is able to be embodied by ribs, teeth, grooves, and/or slots. Such profiling elements are able to extend in a straight line in the direction of the longitudinal axis of the shaft body or also transversely to the longitudinal axis of the shaft body.

In at least one embodiment of the disclosure, a pipe body is positioned therein at a distance from the inner circumference of a hollow component of the shaft body. The pipe body is positioned at a distance from the inner circumference of the first hollow component, which forms the supporting body of the shaft body. In this way, an inner pipe cooling system is able to be implemented.

In at least one embodiment of the disclosure, the pipe body has openings oriented in the longitudinal axis of the shaft body and/or at an angle to the longitudinal axis of the shaft body. Such openings, for example transverse holes in the inner pipe body, or able to be punched or drilled.

A method for producing a hollow shaft according to the disclosure is explained at this point.

In at least one embodiment of the disclosure, the geometry of the shaft body is able to be produced by joining individual rotationally symmetrical hollow components in one another, i.e., pipe into pipe, by means of high-temperature soldering using copper-based, nickel-based, or iron-based solders. Mechanical processing then takes place, wherein only very little mechanical processing effort is necessary.

High-temperature soldering takes place under a controlled protective gas atmosphere. The protective gas atmosphere is able to be formed on the basis of hydrogen, hydrogen/nitrogen mixture, nitrogen, nitrogen-argon mixture, nitrogen-oxygen mixtures, and argon or also able to be implemented by a vacuum.

A temperature range for the high-temperature soldering provided according to the disclosure is between 600° C. and 1,150° C. The selected temperature range depends on the structure of the shaft body and the materials used for the hollow components of the shaft body. The high-temperature soldering is able to be carried out in one pass, in a batch furnace, in a vacuum furnace, or even by means of induction.

With the hollow shaft according to the disclosure and the method, the volume to be machined is significantly or minimally reduced. Processing times are able to be significantly shortened, which enables cost-effective production.

Since the overall geometry of the hollow shaft or its shaft body is modular and is produced by means of high-temperature soldering, various internal geometries of the hollow cylindrical shaft body are able to be produced economically. The same applies to profiles and outer circumferential designs provided or arranged on the outer circumference of the shaft body. In at least one embodiment of the disclosure, different materials are able to be combined with one another, which are designed to be optimized for the respective functional purpose. Rotationally symmetrical hollow components, in pipes, pipe sections, and/or pipe pieces, are able to be defined in terms of corrosion resistance, strength, ductility, or mechanical processing. In addition, high-temperature soldering is also able to be used to substitute heat treatment, such as tempering or hardening, or modified as required to suit the component and requirements.

In at least one embodiment of the disclosure, the hollow cylindrical shaft base body is formed from at least two rotationally symmetrical hollow components placed one inside the other. Manufacturing is able to take place in two manufacturing methods, the technological relationship of which includes the use of soldering technology.

In at least one embodiment of the disclosure, the soldering joining process provides that soldering takes place in a temperature range of approximately 850° C. to 1,150° C., +/−30° C. in each case. Here, the mechanical characteristics of the shaft body and the hollow components joined together are created by a cooling rate adapted to the materials used in a cooling process that follows the joining process. Optionally, the shaft body is able to be tempered at least in some areas, or in its entirety, following the joining process.

A second approach provides a soldering joining process that is carried out in a temperature range between approximately 600° C. and approximately 850° C., +/−30° C. in each case. The soldering joining process takes place in a temperature range below 850° C., preferably below 750° C. Here, the shaft body is constructed from hollow components that have already been at least partially hardened or heat treated before the joining process.

By producing the shaft body using soldering technology from pipe pieces joined together and/or into one another, an internal geometry of the shaft body is able to be designed very variably to form an internal cooling structure. The design of the hollow shaft or its shaft body is matched to the selected cooling concept of the electric motor. The multi-part constructed shaft body according to the disclosure is able to be constructed from hollow components made of different materials as well as different diameters and internal and external geometries. The materials, the material combination, as well as the geometric configuration enable an optimized cooling system, as well as an advantageous lightweight construction of the shaft body.

An electric motor hollow shaft, such as a rotor shaft, which is constructed from rotationally symmetrical hollow components of the same material. The hollow shaft is able to be designed to be functionally optimized and has a high degree of freedom in the design of the internal geometry of the shaft body. The hollow shaft is constructed from at least three rotationally symmetrical hollow components made of the same material. These are able to have different wall thicknesses. The shaft body of a hollow shaft is constructed from rotationally symmetrical hollow components, of which at least three hollow components are joined into one another. These at least three hollow components have a common shaft body central axis.

### BRIEF DESCRIPTION OF THE DRAWINGS

The embodiments of the disclosure are described in more detail hereinafter on the basis of exemplary embodiments illustrated in the drawings. In the technical schematic figures:

FIG. 1 shows a first embodiment of a hollow shaft according to the disclosure;

FIG. 2 a second embodiment of a hollow shaft according to the disclosure;

FIG. 3 shows a third embodiment of a hollow shaft according to the disclosure; and

FIG. 4 shows a fourth embodiment of a hollow shaft according to the disclosure.

### DETAILED DESCRIPTION

In the figures, the same reference numerals are used for identical or functionally corresponding components or component parts, even if a repeated description is omitted for reasons of simplicity. The same applies to dimensions and measurements shown.

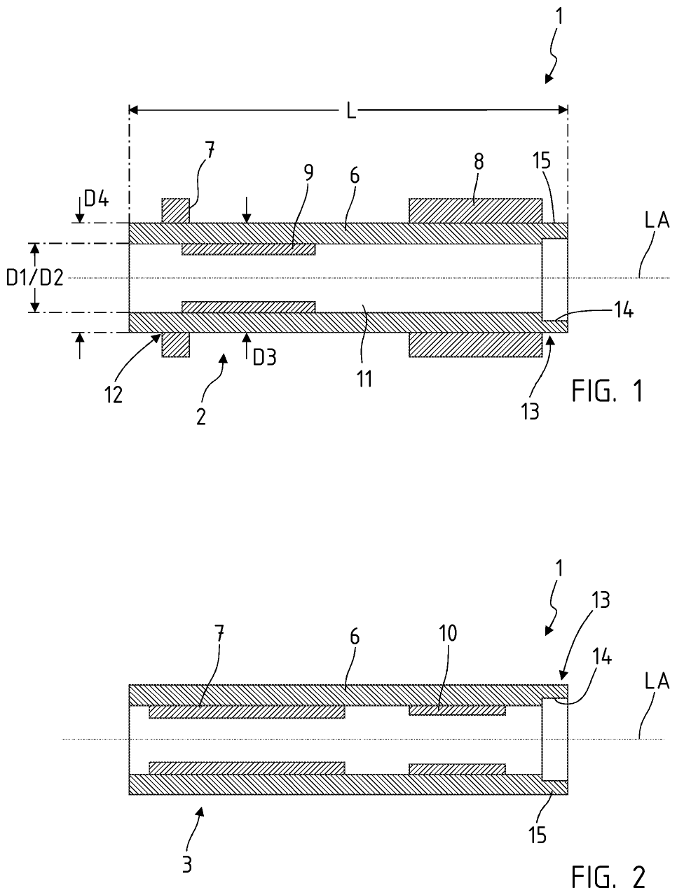

FIG. 1 to FIG. 4 each show a vertical longitudinal section of an electric motor hollow shaft in the form of a rotor shaft 1. Each rotor shaft 1 has a hollow cylindrical shaft body 2, 3, 4, 5, which is formed from multiple rotationally symmetrical hollow components in the form of pipe sections 6, 7, 8, 9, 10. The pipe sections 6-10 are positioned one inside the other and joined together using high-temperature soldering. The soldering joining is carried out by means of high-temperature soldering in a temperature range between 600° C. and 1,150° C. using a copper-based, nickel-based, or iron-based solder. The soldering joining process is carried out under a controlled protective gas atmosphere.

The constructed hollow shaft body 2 of the rotor shaft 1 as shown in FIG. 1 has a first pipe section 6. The first pipe section 6 forms the supporting body of the shaft body 2 and extends over the entire length L of the rotor shaft 1. Further pipe sections 7, 8, 9 are positioned outside on the first pipe section 6 and inside in the first pipe section 6 and are brazed in a materially bonded manner. On the outside of the first pipe section 6, a second pipe section 7 and a third pipe section 8 are joined using soldering. The first pipe section 6 has a central through opening 11 having an inner diameter D1. A fourth pipe section 9 is inserted and positioned in the first pipe section 6. The fourth pipe section 9 has an outer diameter D2, which corresponds to the inner circumference D1 of the first pipe section 6 with a corresponding fit. The fourth pipe section 9 rests with its lateral surface on the inner circumference of the through opening 11 of the first pipe section 6 and is soldered thereto.

The second pipe section 7 and the third pipe section 8 are joined on the outside of the first pipe section 6. The second pipe section 7 and the third pipe section 8 each have a central opening 12 having an inner diameter D3 which corresponds to the outer diameter D4 of the first pipe section 6. The second pipe section 7 and the third pipe section 8 are pushed onto lateral surfaces of the first pipe section 6, positioned, and joined using soldering.

The pipe sections 7, 8, 9 are able to have a profiling. In at least one embodiment of the disclosure, a profiling, for example teeth, is provided on the inner circumference of the fourth pipe section 9 and on the outer circumference of the third pipe section 8. A profiling is able to be formed by teeth, ribs, grooves, or slots.

At the right end 13 of the shaft body 2 in the image plane, a bearing seat 14 is formed in the first pipe section 6. For this purpose, a length section 15 is radially turned out in the end 13 around the circumference.

The shaft body 3 of a rotor shaft 1, as shown in FIG. 2, has a first rotationally symmetrical hollow component in the form of a first pipe section 6, which corresponds to that of the shaft body 2, as described with reference to FIG. 1. The pipe section 6 forms the supporting body of the shaft body 3.

Inside the pipe section 6, two further rotationally symmetrical hollow components, namely a second pipe section 7 and a third pipe section 10, are arranged. The second pipe section 7 and the third pipe section 10 are each positioned in the through opening 11 of the first pipe section 6 and joined there in a materially bonded manner by means of hard-temperature soldering.

A bearing seat 14 is formed in the wall of the first pipe section 6 at least in one end 13.

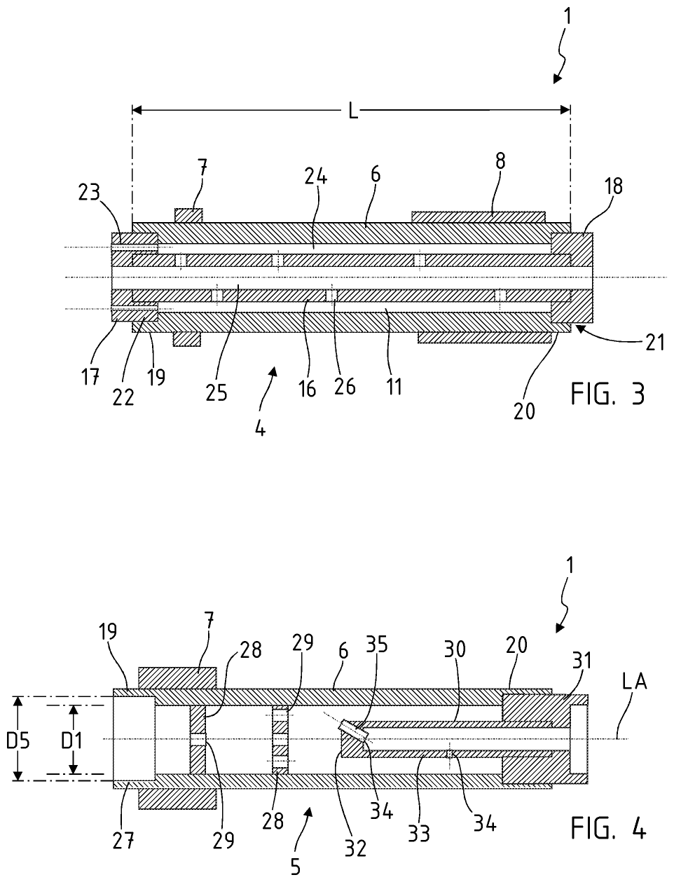

In the rotor shaft 1 shown in FIG. 3, the shaft body 4 includes a first pipe section 6, which forms the supporting body. A second pipe section 7 and a third pipe section 8 are positioned on the outside of the pipe section 6 and joined using soldering by means of brazing. In the interior of the first pipe section 6, a pipe body 16 is arranged at a distance from the inner circumference of the pipe section 6 and extends through the through opening 11 over the length L of the first pipe section 6. The pipe body 16 is held in pipe pieces 17, 18. The pipe pieces 17, 18 are inserted into stepped ends 19, 20 of the pipe section 6 and are also joined there using soldering. A bearing seat 21 is formed on the outer circumference of the pipe pieces 17, 18.

The pipe body 16 integrated into the interior of the pipe section 6 is joined using soldering in inner step sections 22 of the pipe pieces 17, 18.

In at least one embodiment of the disclosure, multiple channels 23 arranged on a partial circle are provided in the pipe piece 17. These pass through the pipe piece 17 lengthwise and establish a connection to the annular space 24, which is formed between the outer circumference of the hollow cylindrical inner pipe body 16 and the inner circumference of the first pipe section 6.

A longitudinal channel 25 extends centrally through the pipe body 16 and the end pipe pieces 17, 18.

The inner pipe body 16 has openings 26 in the form of transverse bores which are provided transversely to the longitudinal axis LA of the shaft body 3 or the first pipe section 6. These are able to be punched or drilled. The openings 26 establish the connection between the longitudinal channel 25 and the annular space 24.

The shaft body 5 of a rotor shaft 1, as shown in FIG. 4, has a first pipe section 6. The first pipe section 6 is the supporting body of the shaft body 5. A second pipe section 7 is positioned on the outer circumference of the first pipe section 6. This encloses the outer lateral surface of the first pipe section 6 and is joined thereto by means of brazing. On the outer circumference, the pipe section 7 is provided with a profiling in the form of teeth. The end 19, 20 of the first pipe section 6 is stepped having a frontal length section 27 which has a larger inner diameter D5 than the inner diameter D1 in the middle length section of the pipe section 6. The length section 27 is able to be designed as a bearing seat.

Two disk bodies 28 are inserted inside the first pipe section 6. These lie with their outer diameter D2 on the inner circumference of the through opening 11 of the first pipe section 6 and are joined thereto using soldering. Through openings 29 oriented in the longitudinal direction of the shaft body 5 or the first pipe section 6 are provided in the disk bodies 28.

Furthermore, a hollow cylindrical pipe body 30 positioned at a distance from the inner circumference is arranged in the first pipe section 6. This is carried by a pipe piece 31, which is inserted into the end 20 of the first pipe section 6 and joined using soldering. A cooling fluid is supplied via the pipe body 30. Openings 34 are provided in the end wall 32, as well as in the longitudinal wall 33 of the pipe body 30, which are oriented in the longitudinal axis LA of the shaft body 5 and/or at an angle to the longitudinal axis LA of the shaft body 5. The opening 34 in the end wall 32 is oriented at an angle to the longitudinal axis LA of the shaft body 5 and accommodates a nozzle insert 35.

In the previously described rotor shaft 1 or the hollow cylindrical shaft bodies 2-5, rotationally symmetrical hollow components, the pipe sections 6-10, are able to be made of the same metallic material. Individual or multiple pipe sections 6-10 each have different materials or have different material quality.

The shaft bodies 2-5 are formed from the pipe sections 6-10, for which purpose these are positioned one inside the other and joined together using soldering. Multiple rotationally symmetrical hollow components in the form of pipe sections 6-10 are positioned one inside the other. The hollow components are arranged concentrically to one another and have a common longitudinal axis LA.

The soldering joining process is able to take place in a temperature range between 850° C. and 1,150° C., each +/−30° C., under a protective gas atmosphere. The joining process is followed by a cooling process of the shaft bodies 2-5. Optionally, a shaft body 2-5 is at least partially annealed.

An alternative production method involves a soldering joining process in a temperature range between around 600° C. and around 850° C., each +/−30° C. The soldering joining takes place at joining temperatures below 850° C., or below 750° C. In this procedure, the shaft bodies 2-5 are constructed from pipe sections 6-10, wherein these are able to be at least partially hardened and/or heat treated.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-9. (canceled)

10. A hollow shaft for an electric motor, the shaft comprising:
a hollow shaft body comprising at least two hollow components, wherein
a first hollow component of the at least two hollow components is inside a second hollow component of the at least two hollow components,
the first hollow component and the second hollow component are joined together via solder,
the first hollow component comprises a central through opening having an inner diameter and a further hollow component is inserted into the first hollow component, wherein the further hollow component is joined to an inner circumference of the central through opening of the first hollow component while abutting thereon.

11. The hollow shaft according to claim 10, wherein the at least two hollow components further comprise at least one further hollow component positioned on an outer circumference of the first hollow component.

12. The hollow shaft according to claim 10, further comprising a bearing seat at least at one end of one of the at least two hollow components.

13. The hollow shaft according to claim 10, wherein the at least two hollow components comprise different metallic materials.

14. The hollow shaft according to claim 10, wherein the solder is a copper-based, a nickel-based, or an iron-based solder.

15. The hollow shaft according to claim 10, wherein at least one of the at least two hollow components comprises a profiling on an inner circumference or an outer circumference thereof.

16. The hollow shaft according to claim 15, wherein the profiling comprises ribs, teeth, grooves, or slots.

17. The hollow shaft according to claim 10, further comprising a pipe body positioned in the shaft body at a distance from the inner circumference of the first hollow component.

18. The hollow shaft according to claim 17, wherein the pipe body comprises openings oriented in a longitudinal axis of the shaft body or at an angle relative to the longitudinal axis of the shaft body.

19. The hollow shaft according to claim 10, wherein the shaft body is a hollow cylinder.

20. The hollow shaft according to claim 10, wherein the at least two hollow components are rotationally symmetrical.
